(19) United States
(12) Patent Application Publication
(10) Pub. No.: US 2004/0094868 A1
(43) Pub. Date: May 20, 2004

(54) Equipment and method of manufacturing an amplifier

(76) Inventor: Wen-Teng Yu, Tao-Yuan Hsien (TW)

Correspondence Address: Wen-Teng YU, P.O. Box No. 6-57, Chung-Ho, Taipei, 235, TW

(21) Appl. No.: 10/294,678

(22) Filed: Nov. 15, 2002

(51) Int. Cl. B29C 45/14

(52) U.S. Cl. 264/259; 425/290; 425/554; 425/127; 425/129.1

(57) ABSTRACT

An equipment and method of manufacturing an amplifier utilizes different injection molding machines to respectively manufacture an external case of an amplifier by using unlimited kinds of material to increase the connection between a diaphragm and a suspension, reduce the cost and enhance the speed of manufacture and the utilization rate of producibility tremendously.

### BACKGROUND OF THE INVENTION

1) Field of the Invention

The present invention relates to an equipment and method of manufacturing an amplifier, more particularly to an innovative manufacturing technique for connecting a diaphragm and a suspension so as to enhance the speed of manufacture, increase the producibility and reduce the cost.

2) Description of the Prior Art

With the advance of technology, the material for comprising an amplifier has become more extensive and the quality thereof has become more sophisticated. It is obvious that the superiority of the designing parameter and the decoration of the external design of the amplifier have been improved to surpass continuously because those factors determine its market potential and suitableness for the consumers.

Accordingly, the amplifier (or the speaker) transmits the sound through an acoustic wave formed in the space via a piston type motion of a diaphragm. However, the diaphragm are made by many compound materials, such as polypropylene, paper, aluminum foil, glass fiber, carbon fiber or woven fabric. The diaphragm connects with a suspension which is made by the traditional material rubber for vibration. The procedure of connecting the diaphragm and the suspension of the conventional amplifier includes manually conducting destruction processing at the connection area of the diaphragm, applying the adhesive and heating to unitize the diaphragm and the suspension. Another connection method is to dispose two mold cavities on one machine; once the diaphragm is manufactured in one of the mold cavities, it is moved into the other mold cavity for injecting the suspension for connecting; sometimes, another layer of adhesive is applied on the connection area for reinforcing the adhesion effect and strength.

However, the abovementioned methods of manufacturing the amplifier are time-consuming and the connection effect is not desired. More particularly, the manufacturing procedure is limited to the same machine for injection molding; the dimension of the molding tool is also limited (less than 8″). In the manufacturing procedure of the prior art, only after the sides of the diaphragm are trimmed, the diaphragm is moved to the next mold cavity for conducting the second injection operation; in other words, it is necessary to allow some waiting time before injecting the suspension to connect the diaphragm. More especially, for connecting the diaphragm and suspension made by different materials (the dual-color injection), it is very difficult to replace or alternate the conventional equipment for disposing the molding tool and for heating. Using the more complicated material for making the diaphragm and the suspension, it is necessary to have more variety of required equipment and suitable molding tools thereby tremendously increasing the cost of injection molding machine.

In summation of the abovementioned, the conventional manufacturing method and equipment are unable to fulfill the demands of time effect, material suitability and the utilization rate of producibility.

### SUMMARY OF THE INVENTION

Therefore, in order to solve the abovementioned problems as well as achieve other effectiveness and objectives, the inventor of the present invention researched and developed an equipment and method of manufacturing an amplifier.

The primary objective of the present invention is to provide an innovative equipment and method of manufacturing the amplifier. The procedure includes (a) injecting and molding a diaphragm; (b) trimming the sides of the diaphragm and punching an eyelet; and (c) using another injection molding machine to directly conduct step (b) for injecting and connecting a suspension.

Particularly, the present invention uses two injection molding machines to solve the problems generated by using the same single machine in prior art operation. More especially, the present invention solves the time delay of waiting for finishing the process of adhering and heating the diaphragm before connecting it with the suspension and avoids the cost increase.

To enable a further understanding of achieving the above-mentioned objectives, the features and the advantages of the present invention, the brief description of the drawings and the detailed description of a preferred embodiment are provided.

### BRIEF DESCRIPTION OF THE DRAWINGS

FIG. 1 is a pictorial drawing of using the first injection molding machine to manufacture a diaphragm according to the present invention.

FIG. 2 is a pictorial drawing of using the second injection molding machine to manufacture a suspension according to the present invention for connecting with the diaphragm.

### DETAILED DESCRIPTION OF THE PREFERRED EMBODIMENTS

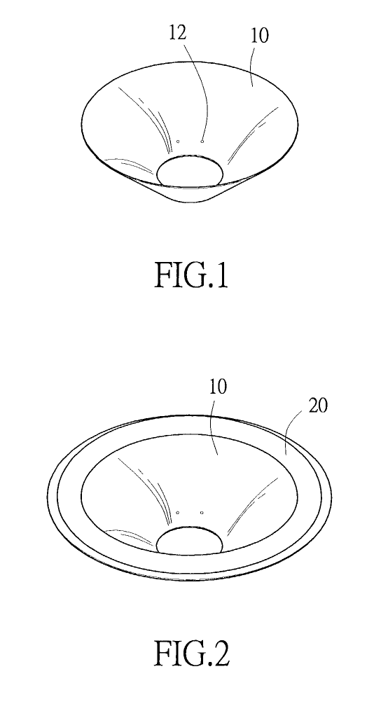

Referring to FIGS. 1 and 2, the present invention of an equipment and method of manufacturing an amplifier comprises at leas the following steps:

(a) injecting and molding a diaphragm (10) or a drum paper;

(b) trimming the sides of the diaphragm (10) and punching an eyelet (12);

(c) using another injection molding machine to directly conduct step (b) for injecting and connecting a suspension (20).

Wherein, steps (a) and (b) are accomplished by an independent injection molding machine while step (c) uses another independent injection molding machine for finishing the connecting operation with the suspension (20). Said manufacturing method is suitable for any suspension (20) material, such as rubber, plastic, thermoplastic elastomer or thermoplastic rubber. Using two independent injection molding machines solves the problem of allowing some waiting time during the manufacture procedure. In other words, the machine for injecting the diaphragm (10) is not influenced by the other machine equipment; it is capable of continuously manufacturing the diaphragm (10) and using different molding tools to fit different diaphragm materials so as to completely fulfill the utilization of producibility.

As indicated in FIG. 2, the suspension (20) is formed on the peripheral rim of the diaphragm (10) for mainly benefiting the vibration of the diaphragm (10). The color and the external appearance of the suspension (20) vary according to the design of the amplifier. The color is not limited to a monotonous black rubber color. At least two eyelets (12) are disposed on the diaphragm (10). That technique is of a prior art and will not be further described hereon.

In summation of the abovementioned, the present invention provides an equipment and method of manufacturing an amplifier to specifically achieve many effects and suit more variety of materials. Particularly, the present invention is capable of fully fulfilling the producibility, increasing the connection effectiveness and reducing the cost. With the available technique, it is possible to specifically achieve the said effect and objective by using two independent machines to finish the manufacturing procedure operated on a single injection molding machine. With the advantage of time and space background, the manufacturing method of the present invention surpasses the prior art in terms of the material and molding tool. Therefore, the present invention is innovative and advanced as described above.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An equipment and method of manufacturing an amplifier includes the following steps:
(a) injecting and molding a diaphragm or a drum paper;
(b) trimming the sides of the diaphragm and punching an eyelet;
(c) using another injection molding machine to directly conduct step for injecting and connecting a suspension.

2. The equipment and method of manufacturing an amplifier according to claim 1, wherein the suspension material includes rubber, plastic or thermoplastic rubber.

3. The equipment and method of manufacturing an amplifier according to claim 1, wherein the suspension is formed on the peripheral position of the diaphragm.

4. The equipment and method of manufacturing an amplifier according to claim 1, wherein at least two eyelets are disposed on the diaphragm.

5. An equipment of manufacturing an amplifier comprising:
an injection molding machine for manufacturing the diaphragm and capable of trimming the sides of the diaphragm and punching the eyelets;
an injection molding machine for injecting a suspension for connecting with the trimmed sides of the diaphragm.

6. The device for manufacturing an amplifier according to claim 5, wherein the suspension material includes rubber, plastic or thermoplastic rubber.

7. The device for manufacturing an amplifier according to claim 5, wherein the suspension is formed on the peripheral position of the diaphragm.

8. The device for manufacturing an amplifier according to claim 5, wherein at least two eyelets are disposed on the diaphragm.
